(19) United States
(12) Patent Application Publication
(10) Pub. No.: US 2025/0159716 A1
(43) Pub. Date: May 15, 2025

(54) NETWORK NODE AND A METHOD IN A WIRELESS COMMUNICATIONS NETWORK

(71) Applicant: Telefonaktiebolaget LM Ericsson (publ), Stockholm (SE)

(72) Inventors: Ola Lundqvist, Karlstad (SE); Tomas Svadling, Hammaro (SE)

(21) Appl. No.: 18/728,728

(22) PCT Filed: Nov. 22, 2022
(86) PCT No.: PCT/EP2022/082800

§ 371 Date: Jul. 12, 2024

Related U.S. Application Data
(60) Provisional application No. 63/266,729, filed on Jan. 13, 2022.

(51) Int. Cl. H04W 72/56

(52) U.S. Cl. CPC H04W 72/56

(57) ABSTRACT

A method performed by a network node is provided. The method is for handling radio resources for an upcoming first technology transmission between the network node and a first technology device in a wireless communications network. The radio resources are shared between first technology transmissions and second technology transmissions. The first technology transmissions relate to transmissions that are bandwidth limited. The second technology transmissions relate to any one or more out of: Long Term Evolution, LTE, and New Radio, NR, transmissions. The network node estimates (203) first technology resources used for first technology transmissions in a shared radio resource. The network node determines (204) whether or not one or more criteria related to the estimated first technology resources are fulfilled. When the one or more criteria are fulfilled, the network node adjusts (205) a priority order for the upcoming first technology transmission to be lower than a given priority order in the radio resource to be shared. The adjusted priority order is in favour for the second technology transmissions. When the one or more criteria are not fulfilled. the network node keeps (206) the given specific priority order for the upcoming first technology transmission in the radio resource to be shared.

### TECHNICAL FIELD

Embodiments herein relate to a network node, and methods therein. In some aspects, they relate to handling radio resources for an upcoming first technology transmission between the network node and a first technology device in a wireless communications network, which radio resources are shared between first technology transmissions and second technology transmissions.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Category Machine (Cat-M), Category Machine 1 (Cat-M1) and Category Machine 2 (Cat-M2), also known as LTE Cat-M, relate to a low-cost Low Power Wide Area Network (LPWAN) technology developed by 3GPP as part of the 13th edition of the LTE standard. It's a complementary technology to Narrow Band (NB) Internet of Things (IOT),

Operators want to have LTE and Cat-M1 in the same carrier bandwidth or with Dynamic Spectrum Sharing LTE, NR and Cat-M1 in the same carrier bandwidth. There are many ways to prioritize transmissions. E.g., according to transmission priority, capacity and other steering functions such as prioritizing LTE over NR, fair, or NR over LTE. Other methods may be possible as well.

Some operators also want to have support for Cat-M Multiple Narrowbands since there are cases with high load on Cat-M1 while the load is low or medium load on NR and LTE.

The IoT, including Cat-M1, traffic pattern typically has a small amount of data, no more than a few kB in Uplink (UL) and Downlink (DL), meaning that most resource consumption is on the Signaling Radio Bearer (SRB). Typically, the resource usage is between 75% to 95% on the SRB, and the rest on the Data Radio Bearer (DRB).

There are multiple SRBs, such as SRB0, SRB1 and SRB2. SRB0 is an SRB used for random access. SRB1 is an SRB used for Radio Resource Control (RRC) signaling and Non-Access Stratum (NAS) before SRB2 is available. SRB2 is an SRB used for NAS signaling.

Since SRB signaling, typically, has higher priority than DRB transmissions, this means that in general Cat-M1 has almost always priority over LTE due to the traffic pattern. The impact on NR and LTE scales with the number of supported Cat-M1 narrow bands.

It is possible to control the number of available narrow bands, but with the effect that high Cat-M1 transmission load scenarios cannot be supported. With only a single Narrow band setup for Cat-M1, the number of simultaneous supported Cat-M1 UE's is severely limited and cannot handle high burst of Cat-M1 UE's accessing the network at the same time.

A problem with prior art will be identified and discussed in the description part below.

### SUMMARY

An object of embodiments herein is to improve the performance in a wireless communications network using shared radio resources.

According to an aspect, the object is achieved by a method performed by a network node. The method is for handling radio resources for an upcoming first technology transmission between the network node and a first technology device in a wireless communications network. The radio resources are shared between first technology transmissions and second technology transmissions. The first technology transmissions relate to transmissions that are bandwidth limited. The second technology transmissions relate to any one or more out of: Long Term Evolution, LTE, and New Radio, NR, transmissions. The network node estimates (203) first technology resources used for first technology transmissions in a shared radio resource. The network node determines (204) whether or not one or more criteria related to the estimated first technology resources are fulfilled. When the one or more criteria are fulfilled, the network node adjusts (205) a priority order for the upcoming first technology transmission to be lower than a given priority order in the radio resource to be shared. The adjusted priority order is in favour for the second technology transmissions. When the one or more criteria are not fulfilled, the network node keeps (206) the given specific priority order for the upcoming first technology transmission in the radio resource to be shared.

According to another aspect, the object is achieved by a network node. The network node is configured to handle radio resources for an upcoming first technology transmission between the network node and a first technology device in a wireless communications network. The radio resources are arranged to be shared between first technology transmissions and second technology transmissions. The first technology transmissions relate to transmissions that are bandwidth limited. The second technology transmissions are adapted to relate to any one or more out of: Long Term Evolution, LTE, and New Radio, NR, transmissions. The network node is further configured to:
Estimate, first technology resources used for first technology transmissions in a shared radio resource, and
determine whether or not one or more criteria related to the estimated first technology resources, are fulfilled, and
when the one or more criteria are fulfilled, adjust a priority order for the upcoming first technology transmission to be lower than a given priority order in the radio resource to be shared, which adjusted priority order is adapted to be in favour for the second technology transmissions, and
when the one or more criteria are not fulfilled, keep the given specific priority order for the upcoming first technology transmission in the radio resource to be shared.

Some advantages of embodiments herein e.g. comprise the following:

An advantage of embodiments herein is that dynamic first technology shares may be defined to be used to limit first technology resource usage when the demand on second technology resource usage is high, while when the demand of second technology resources is low, first technology devices may use all available resources when needed due to first technology demands. This makes it possible to have high first technology capacity while limiting the first technology resource utilization when the second technology demand is high.

### BRIEF DESCRIPTION OF THE DRAWINGS

FIG. 1 is a schematic block diagram depicting embodiments of a wireless communications network.

FIG. 2 is a flow chart depicting embodiments of a method performed by a network node.

FIGS. 3a and b are schematic block diagrams depicting embodiments of a network node.

FIG. 4 schematically illustrates a telecommunication network connected via an intermediate network to a host computer.

FIG. 5 is a generalized block diagram of a host computer communicating via a base station with a user equipment over a partially wireless connection.

FIGS. 6 to 9 are flowcharts illustrating methods implemented in a communication system including a host computer, a base station and a user equipment.

### DETAILED DESCRIPTION

As a part of developing embodiments herein the inventors identified a problem which first will be discussed.

It would be excellent if a Cat-M1 transmission could use the full bandwidth when the Cat-M1 transmission load is high, but let it use no more than some percentage of the shared resources when NR and/or LTE is in high demand.

Scheduling decisions are made in priority order and hence resources are given in e.g. a corresponding priority order. The exact method may vary.

There are multiple ways to let different groups of devices share resources or limit the usage in one way or another.

LTE and Cat-M1 devices has very different average traffic profiles.

LTE devices are typically for mobile broadband which means relatively few connection establishments and large, several megabytes or more, amount of data transmitted. Downlink is typically more heavily used than uplink. The ratio is at least five times more downlink data than uplink.

Cat-M1 devices are typically metering devices, trackers or similar transmitting just a small amount, e.g. <3 kilobyte, of data where uplink and downlink are equally used, or in some cases more uplink than downlink.

Cat-M1 transmissions often utilizes a lot of repetitions. In the 3GPP TS 36.211 V13.2.0 the following is the maximum number of repetitions values for CE Mode A, but lower values can be set by the eNB.
Cat-M1 Physical Downlink Control Channel (MPDCCH) 16
Physical Downlink Shared Channel (PDSCH) 32
Physical Uplink Shared Channel (PUSCH) 32

The 3GPP TS 36.211 V13.2.0 standard allows much larger number of repetition values for the MPDCCH, PDSCH and PUSCH in CE Mode B: however:
MPDCCH 256
PDSCH 2048
PUSCH 2048

There are also several methods of estimating the resource usage, like:
Linear average over a rolling period.
Linear average over a fixed period.
Exponential filter of type Eₙ₊₁=Eₙ*(1−F)+Vₙ*F

Where
Eₙ is the estimated average value in subframe n
F is a fixed filter value, 0<=F<=1.
Vₙ is the measured value for subframe n

The following SRBs may be used:
SRB0 for random access and contention resolution
SRB1 used after contention resolution for RRC and Non-Access Stratum (NAS) before SRB2 is established) signaling
SRB2 use for NAS signaling.

SRB0 is time sensitive due to timers:
Random Access (RA) response window
Contention Resolution Timer
T300

There are a multitude of problems with the existing method.

The existing “Resource Partition” function differentiate groups of users using Public Land Mobile Network (PLMN) or Service Profile Identifier (SPID). Since Cat-M1 devices do not necessarily have a separate PLMN, only the SPID approach would remain.

The existing Resource Partition do not partition resources used for SRB since the PLMN is not known at that point. Since Cat-M1 SRB resource utilization is approximately 75% to 95% of the resource usage, this becomes a very ineffective way to limit Cat-M1 resource usage.

Estimation of Cat-M1 resources is somewhat of a challenge due to the repetitions resulting in very long measurement periods. More information about this described below.

Existing resource estimation functionality forgets too quickly meaning that it cannot meet the configured resource share when there are repetitions scheduled.

Due to the excessive SRB usage for Cat-M1 devices it is not enough to adjust down the priorities a little, it must be adjusted down a lot.

Partitioning of SRB resources is a problem area itself. SERB0 is time critical which means that if resources are limited in this phase, a UE will not be able to establish an RRC connection to the network, and what is even worse, if it fails it will try again, and again, and again, and then it will escalate to a higher Coverage Extension (CE) level causing even more resource usage. A CE level when used herein may mean Coverage Extension technique by using repetitions. CE level 1 allows for more repetitions than CE level 0 SRB1 and SRB2 do not have those time constraints, but still cannot be limited too much.

The known algorithms for estimating the resource usage on a carrier were simulated with different period and filter constants with the following conclusions:
A rolling average over a rolling period for determining Cat-M1 traffic load on the carrier has the undesired effect that Cat-M1 devices are allowed a few times in the beginning, and then not allowed, by this introduced functionality, for the rest of the period. This is generally not desired and for SERB0 it does not work due to the time constraints.
An average over a fixed period for determining traffic load on the carrier has the undesired effect that Cat-M1 devices are allowed for a few times in the beginning of that fixed period and then not allowed for the rest of that period. This is generally not desired and for SERB0 it does not work due to the time constraints.
The average period for determining traffic load on the carrier must be long, and the length depends on the resource usage threshold and the maximum repetitions. If not, the threshold cannot be met.
Linear average over a long period for determining traffic load on the carrier which is needed to meet the requirements when repetitions are in place, results in a long period of no Cat-M1 traffic, when the limitation kicks in, while waiting for the estimated resources to go down. This means that functions like Voice will not work and in addition the excessive waiting time may result in that the eNB or the UE releases the connection due to inactivity. A long average time has two disadvantages: It may block Cat-M service for long time and time critical service link Cat-M1 Voice over LTE (VOLTE) will not be possible, but it also means that it reacts slow, and the other RATs like NR might already have had its busy period before Cat-M1 traffic is finally down-prioritized and hence give no of very little gain for the other RATs

An object of embodiments herein is to improve the performance in a wireless communications network using shared radio resources.

Example of embodiments herein provide a combination of at least some of the following actions for a first technology resource, such as e.g. Cat-M1 resource to be shared with second technology resource such as e.g. an NR and/or an LTE resource, in a shared radio resource.
A network node estimates an average first technology resource usage of first technology transmissions in the shared radio resource.
The network node determines whether or not one or more criteria related to the estimated first technology resources are fulfilled, e.g. checks a threshold parameter for that share.
When fulfilled, e.g. one or more thresholds are exceeded, a priority order for the upcoming first technology transmission is down adjusted, in favour for the second technology transmissions. E.g. the prioritization is changed downwards when the estimated average use for that share is above the threshold parameter for that share.
When not fulfilled, the current a priority order is kept.

The network node may associates a map between the first technology, e.g. Cat-M1, transmission type and its related share.

An advantage of embodiments herein is that dynamic first technology shares may be defined to be used to limit first technology resource usage when the demand on second technology resource usage is high, while when the demand of second technology resources is low, first technology devices may use all available resources when needed due to first technology demands. This makes it possible to have high first technology capacity while limiting the first technology resource utilization when the second technology demand is high.

E.g., dynamic Cat-M1 shares may be defined for limiting Cat-M1 resource usage when the demand on LTE or NR is high, while when the demand on LTE and NR is low, Cat-M1 may utilize all available resources when needed due to Cat-M1 demands. This makes it possible to have high Cat-M1 capacity while limiting the Cat-M1 resource utilization, to the threshold, when the NR or LTE demand is high.

Limiting the possibility to schedule first MPDCCH repetition and excluding paging, is an effective way to reduce the Cat-M1 resource usage while not giving dramatic Key Performance Indicators (KPI) impact.

The below criteria, such as e.g. thresholds, relating to resource utilization in different kind of cases effectively limit the first technology such as Cat-M1,

A criteria related to DL Share is effective in most cases since DL is typically the limiting resource, and it does not protect against a situation when a lot of devices make connection attempts close in time.

A criteria related to SERB0 Share is effective in a situation when a lot of devices make connection attempts close in time.

A criteria related to UL Share is effective in the case DL is not the limiting resource. This may happen if there are multiple PUSCH repetitions scheduled and no or very few DL repetitions scheduled.

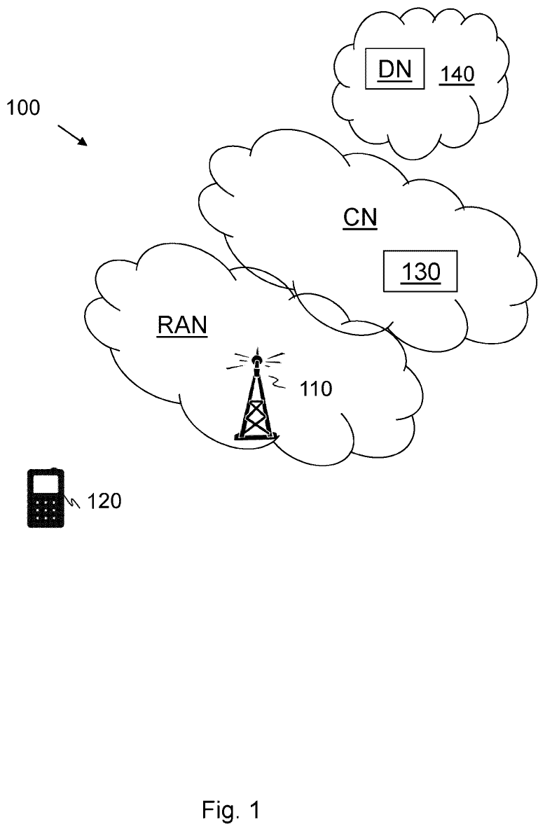

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The network node 110 e.g. provides a number of cells referred to as cell1 and cell2, and may use these cells for communicating with e.g. first technology device 120 such as an M1-device. The network node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any of cell1 and cell2 served by the network node 110 depending e.g. on the radio access technology and terminology used.

User Equipments operate in the wireless communications network 100, such as a first technology device 120 and a second technology device 122. The first technology device 120 operates according to a first technology, such as Cat-M1 technology. The second technology device 122 operates according to a second technology, such as NR and/or LTE technology.

The first technology device 120 may provide radio coverage by means of a number of antenna beams 127, also referred to as beams herein.

The first technology device 120 and the second technology device 122 may each e.g. be an NR device, a mobile station, a wireless terminal, an NB-IoT device, an eMTC device, an NR RedCap device, a CAT-M device, a CAT-M1 device, a CAT-M2 device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the network node 110. As an alternative, a Distributed Node (DN) and functionality, e.g. comprised in a cloud 140 as shown in FIG. 1, may be used for performing or partly performing the methods.

According to an example of the principle applied to a specific resource share, is that when the estimated first technology Physical Resource Block (PRB) usage, e.g. a Cat-M PRB usage, fulfils a criterion, such as e.g. reaches over an operator configurable threshold, a first technology transmission, e.g. a Cat-M1 transmission, is down-prioritized in favor of second technology transmissions e.g. LTE and NR transmissions. This is performed by changing from the normal priority to a low priority for the first technology transmission, lower than typical DRB priority.

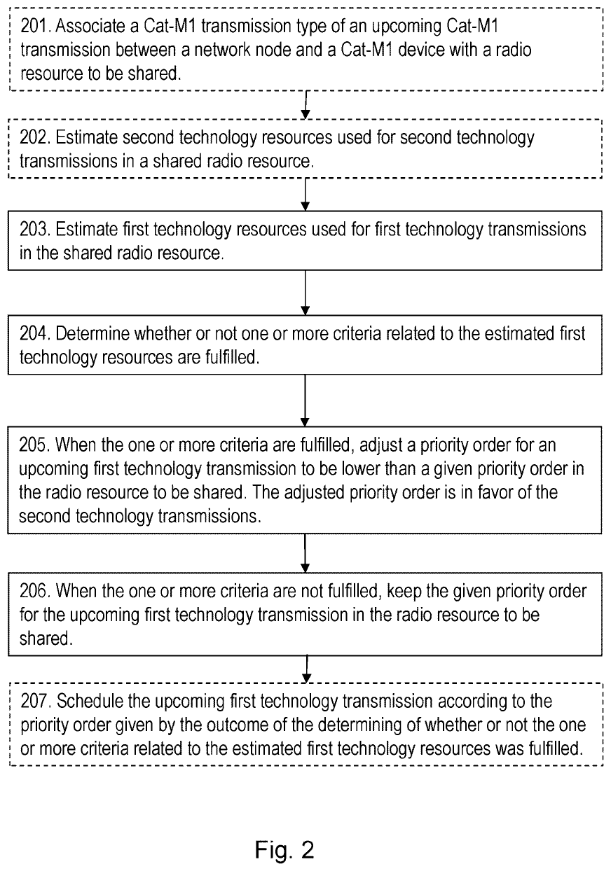

FIG. 2 shows an example method performed by the network node 110. The method is e.g. for handling radio resources for an upcoming first technology transmission between the network node 110 and the first technology device 120 in a wireless communications network 100. The first technology device 120 may e.g. be an Cat-M1, Cat-M or Cat-M2 device. The radio resources are shared between first technology transmissions and second technology transmissions. The first technology transmissions relate to transmissions that are bandwidth limited. The bandwidth limited transmissions may e.g. use repeated transmissions, such as e.g. Cat-M1, Cat-M and Cat-M2 transmissions. The second technology transmissions relate to any one or more out of: LTE, and NR transmissions.

The method comprises any one or more out of the actions below:

### Action 201

This action is optional. The network node 110 may associate a first technology transmission type of an upcoming first technology transmission between the network node 110 and the first technology device 120 with the radio resource to be shared.

E.g., the network node 110 may associate a Cat-M1 transmission type, of an upcoming Cat-M1 transmission, between the network node 110 and a Cat-M1 device with the radio resource to be shared.

This information is later used to determine which criteria to use when deciding whether to adjust or keep a priority order for the upcoming first technology transmission.

See e.g. Table 1 below that illustrates a mapping, also referred to as associating, of type of transmission to the radio resource to be shared.

### Action 202

In some embodiments, the network node 110 estimates second technology resources used for second technology transmissions in the shared radio resource. The estimated second technology resources may in some embodiments be taken into consideration when later on estimating first technology resources in Action 203 below.

The second technology resources may be estimated in terms of PRB usage in ongoing and/or upcoming second technology transmissions.

### Action 203

The network node 110 estimates first technology resources used for first technology transmissions in the shared radio resource. This estimate will be used later on as a basis to decide whether to adjust or keep a priority order for the upcoming first technology transmission.

The first technology resources may be estimated in terms of required PRB usage for the upcoming first technology transmission.

In the embodiments wherein the network node 110 has estimated the second technology resources used for second technology transmissions in the shared radio resource, the network node 110 further takes the estimated second technology resources into consideration when estimating the first technology resources used in first technology transmissions in the shared radio resource.

It should be noted that the first technology resource estimations may in some embodiments be performed without considering if second technology resource estimations criteria can be fulfilled.

### Action 204

The network node 110 then determines whether or not one or more criteria related to the estimated first technology resources are fulfilled and/or exceeded. The one or more criteria related to the estimated first technology resources, may e.g. be one or more thresholds. This determination will be used for deciding whether to adjust or keep a priority order for the upcoming first technology transmission.

The one or more criteria related to the estimated first technology resources may relate to any of: a DL resource share, an SERB0 share, and an UL resource share.

The one or more criteria are represented by three threshold parameters, comprising a threshold value for shared radio resources in any of:
Signalling Radio Bearer, SRB, 1 SRB2, and Data Radio Bearer, DRB, first technology resource Downlink, DL,
SRB1, SRB2 and DRB first technology resource Uplink, UL, and
SERB0 first technology resource DL, and DL DRBs

### Action 205

When the one or more criteria are fulfilled, e.g. the one or more thresholds are exceeded and/or fulfilled, the network node 110 adjusts a priority order for the upcoming first technology transmission to be lower than a given priority order in the radio resource to be shared. The adjusted priority order is in favour for the second technology transmission. To be in favour for the second technology transmission may e.g., mean that the second technology transmission is prioritized over the first technology transmission.

### Action 206

When the one or more criteria are not fulfilled, e.g., the one or more thresholds are not exceeded, the network node 110 keeps the given priority order for the upcoming first technology transmission in the radio resource to be shared.

### Action 207

The network node 110 may then schedule the upcoming first technology transmission according to the priority order given by the outcome of the determining of whether or not the one or more criteria related to the estimated first technology resources, e.g. one or more thresholds, was fulfilled.

When the one or more criteria are fulfilled, the first technology transmission is scheduled according to a priority order that is adjusted to be lower than the given priority order in the radio resource to be shared. This lower priority order gives favour for the second technology transmissions.

When the one or more criteria are not fulfilled the first technology transmission is scheduled according to the kept given specific priority order for the upcoming first technology transmission in the radio resource to be shared. This kept priority order may give favour for the upcoming first technology transmission.

The method will now be further explained and exemplified in below embodiments. These below embodiments may be combined with any suitable embodiment as described above.

In examples herein, the first technology resource may e.g. be represented by a CatM1 PRB, the first technology transmission may e.g. be represented by be a Cat-M1 transmission, and the second technology transmissions may e.g. may e.g. be represented by LTE and/or NR transmissions.

Embodiments herein allow an operator to configure parameters, such as the one or more criteria, e.g. thresholds, for controlling the sharing of the radio resource between the first technology transmission and the second technology transmissions. The network node 110, such as its scheduler, will then try to fulfill that resource share, in subframes where there is a resource conflict according to whether the one or more criteria are fulfilled embodiments herein.

When the estimated first technology resource use reach over the operator configurable one or more criteria, the first technology transmission is down-prioritized in favor of the second technology transmissions. This is performed by changing first technology transmission priority to a priority below a typical DRB priority for the second technology transmissions.

E.g., when a estimated Cat-M1 PRB use reach over the operator configurable threshold, the Cat-M1 transmission is down-prioritized in favor of LTE and NR. This may be performed by changing Cat-M1 priority to a priority below typical DRB priority for LTE and/or NR.

When the network node 110, such as its scheduler unit, require radio resources from different shares, a down-prioritization of the first technology transmission may take place if any of the one or more criteria are fulfilled, such as e.g. if any one or more thresholds are reached.

The scheduling decisions in the network node 110 may be made in priority order and in a way that avoids using the same resources more than once. This is the same handling as in prior art.

Once a scheduling, such as a scheduling decision, is made, all transmissions related to that scheduling decision are fulfilled. There are no partial scheduling decisions. This will be explained more below.

A PRB threshold when used herein may be a %-age of the total available PRBs, or a fixed threshold. In some embodiments the number of PRBs with one decimal precision may be used.

There is e.g., a dependency between a criterion such as a PRB threshold, and how long memory time the system needs for the PRB usage. The reason is that a scheduling decision may result in a PRB usage for a number of subframes of a transmission. If the threshold is low this means that the time the memory needs will be rather large, so a new scheduling decision is not made before the average PRB usage has gone down below the PRB threshold.

### Criteria Relating to Threshold Parameters

There are multiple possible embodiments where the one or more criteria, in these examples represented by three threshold parameters, may be implemented.
A threshold value for shared radio resources in SRB1, SRB2 and DRB first technology resource DL, e.g. Cat-M1 DL, (MPDCCH and PDSCH) PRBs, named DL share or dlShare.
A threshold value for shared radio resources in SRB1, SRB2 and DRB first technology resource UL, e.g. Cat-M1 UL (PUSCH) DRBs, named UL share or ulShare.
A threshold value for shared radio resources in SERB0 first technology resource DL, e.g. Cat-M1 DL (MPDCCH and PDSCH) DRBs, named SR0 share or srb0Share.

For each threshold value there is an associated set of PRB resources e.g. PRBs used for SRB1, SRB2 and DRB transmissions. See Table 1 below. This means that the first technology resources to be estimated may comprise a set of resources. For this to work effectively, the set of resources measured should advantageously be identical or close to identical to the resources that a scheduling decision applies to.

### Resource Estimation

There are multiple embodiments for the first technology resource estimations. Since an exponential filter is the one that gives the best result, only embodiments with that filter are described.

The first technology resource estimations may in some embodiments be performed without considering if second technology resource estimations criteria can be fulfilled. E.g. without considering whether LTE and NR demand can be fulfilled.

$${E}_{s , n} = {E}_{s , n - 1} * ( 1 - {F}_{s} ) + {V}_{s , n} * {F}_{s}$$

Wherein:

Eₛ is the estimated first technology resource for share, in this example, the estimated PRB use for share ₛ.

Fₛ is the filter constant for share ₛ. A filter constant for share when used herein is further described below in the filter constant selection section.

Vₛ is the actual first technology resource use, in this example, the actual PRB use, associated with resource share ₛ in subframe ₙ.

ₛ is the resource share. Resource share when used herein in some embodiments relate to the resource share with examples in Table 1 below.

ₙ is the subframe of the radio resource for which the first technology estimation, e.g. measurement, takes place.

In some embodiments, the first technology resource estimations are performed by considering if the second technology resource estimations criteria can be fulfilled. E.g. by considering whether LTE and NR demand can be fulfilled.

The motivation for this is to ensure that the first technology resource usage, such as e.g. the Cat-M1 resource usage, is not estimated to be high above the threshold when the second technology resources demand, such as the NR and/or LTE demand starts to be high. If the estimated first technology resource usage, such as the estimated Cat-M1 usage, is high at that point, the result is that the first technology transmissions, such as the Cat-M1 transmissions, must wait for a long time. This is problematic for latency sensitive transmissions like SRB0 transmissions and voice.

```
If Ds == true
  X = min(V_{s,n}, Tₛ)
Else
  X = V_{s,n}
Endif
```

Wherein:

X is a temporary value used,

min(V_{s,n}, Tₛ) is a mathematical “min” function returning the smallest value of the arguments.

Endif is a directive that marks the end of an if statement.

$${E}_{s , n} = {E}_{s , n - 1} * ( 1 - {F}_{s} ) + X * {F}_{s}$$

Wherein:

Eₛ is the estimated PRB use for share ₛ

Fₛ is the filter constant for share ₛ.

Vₛ is the actual PRB use associated with share ₛ in subframe ₙ.

ₛ is the share.

ₙ is the subframe for which the measurement takes place

Tₛ is the threshold for share ₛ.

Dₛ is a Boolean indicating whether LTE and NR demand can be fulfilled or not.

It is true if the second technology resource demand, such as e.g. the NR and/or LTE demand was lower than the available PRBs and false if the demand is higher than the available PRBs. There are multiple ways to conclude whether the second technology resource demand, such as e.g. the NR and/or LTE demand can be fulfilled. It may be calculated from a previous subframe, this subframe or in some other time-frame. It may be calculated with approximated demands or based on whether all resources are utilized. With dynamic spectrum sharing implementation, Dₛ is indicated by a controller based on demands for previous subframe.

### Filter Constant Selection

The value of the filter constant Fₛ may be a delicate matter.

A too large filter constant value results in that resources are forgotten too quickly meaning that the down-prioritization takes place too seldomly and therefore the criterion, e.g. the threshold, has too little effect.

A too small filter constant value means that it takes too long time for the down-prioritization to start. This is especially problematic when second technology resource usage, such as e.g. the NR and/or LTE resource usage, comprises frequent bursts.

The following formula was concluded to be advantageous:

$${F}_{s} = min ( Gs * Ts / Rs , Ms )$$

Wherein:

Gₛ is a constant between 0 and 1. A value between 0.1 and 0.3 was found to work well in simulations, with e.g. a maximum of 32 repetitions. and the best effect in simulations was with a value of 0.2 or 0.25 with e.g. a maximum of 32 repetitions.

Fₛ is the filter constant for share ₛ.

Tₛ is the threshold for share ₛ.

Rₛ is the maximum repetitions for the share.

Ms is the maximum filter constant allowed. The value depends on the minimum allowed repetitions.

### Down-Prioritization

For some embodiments herein, the prioritization adjustment is done as described below. This is related to and may be combined with Action 205.

For a scheduling unit W, with priority P_{w} in a specific subframe:

### A Shared SRB0 (srb0Share)

If E_{srb0share,n} > T_{srb0share}
P_{w} = lowest
Endif

Wherein:

E_{srb0share,n} is the estimated first technology resource usage for SRB0 transmissions.

T_{srb0share} is the threshold for first technology resource usage for SRB0 transmissions.

### A Shared DL (dlShare)

If E_{dlshare} > T_{dlShare}
P_{w} = lowest
Endif

Wherein:

E_{dlshare} is the estimated first technology resource usage for downlink transmissions, excluding the ones for SRB0.

T_{dlShare} is the threshold for first technology resource usage for downlink transmissions, excluding the ones for SERB0.

### A Shared UL (ulShare)

If E_{dlshare} > T_{dlShare} OR E_{ulShare} > T_{ulShare}
P_{w} = lowest
Endif

Wherein:

Eᵤₗₛₕₐᵣₑ is the estimated first technology resource usage for uplink transmissions.

T_{ulShare} is the threshold for the first technology resource usage for uplink transmissions.

### Cat-M1 transmissions never part of any Cat-M1 resource share and thus never down-prioritized.

The following scheduling decisions may not consider any threshold: SIB1-BR, SIB and Paging. BR when used herein e.g. means Bandwidth Reduced. The reasons are the following:sss
A SIB1-BR being lost causes devices trying to search for cells further away and that would result in much higher load on those cells.
A SIB being lost results in the same problem as when SIB1-BR is lost.
Paging being lost would result in a significant increase in silent Paging discard rate. The network node 110 has no possibility to re-send this at a later time and thus must rely on a Mobility Management Entity (MME) to re-send it and then it may be lost again.

### Motivation for why decisions are followed through

The reason why there are no partial scheduling decisions may be:
MPDCCH repetitions being lost would result in coverage loss and rather significant increase in resource usage, which would defeat the purpose.
PDSCH being lost would result in coverage loss and rather significant increase in resource usage, which would defeat the purpose.
PUSCH is always transmitted by a UE, such as e.g. the first technology device 120, according to the information in the MPDCCH Downlink Control Information (DCI). There is no possibility to revoke an earlier DCI. It would not even be possible with standardization changes since the UE is half duplex.

### First technology, such as Cat-M1, Resource Shares

Table 1 below illustrates a mapping of type of transmission to the share.

TABLE 1

| Transmission type | Share |
|---|---|
| SIB1-BR PDSCH | — |
| SIB PDSCH | — |
| Common Search Space (CSS) type 1 (Paging) MPDCCH | — |
| PDSCH scheduled by MPDCCH CSS type 1 | — |
| CSS type 2 MPDCCH | SRB 0 share |
| PDSCH scheduled by MPDCCH CSS type 2 | SRB 0 share |
| MPDCCH UE Specific Search Space (UESS) and CSS | DL share |
| type 0 | |
| PDSCH scheduled by MPDCCH UESS or CSS type 2 | DL share |
| PUSCH | UL share |

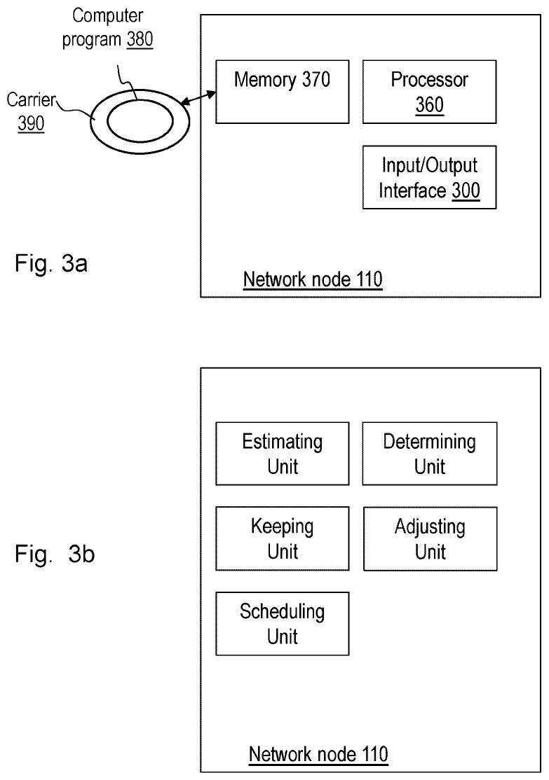

FIGS. 3a and 3b shows an example of arrangement in the network node 110.

The network node 110 may comprise an input and output interface 300 configured to communicate with other networking entities, e.g., the first technology device 120. The input and output interface may comprise a receiver, e.g., wired and/or wireless, (not shown) and a transmitter, e.g., wired and/or wireless, (not shown).

The network node 110 may comprise any one or more out of: An estimating unit, a determining unit, an adjusting unit, a keeping unit, and a scheduling unit to perform the method actions as described herein.

The network node 110 is configured to handle radio resources for an upcoming first technology transmission between the network node 110 and the first technology device 120 in a wireless communications network 100. The radio resources are arranged to be shared between first technology transmissions and second technology transmissions. The first technology transmissions relate to transmissions that are bandwidth limited, and wherein the second technology transmissions are adapted to relate to any one or more out of: Long Term Evolution, LTE, and New Radio, NR, transmissions. the network node 110 is further configured to:
Estimate, first technology resources used for first technology transmissions in a shared radio resource, and
determine whether or not one or more criteria related to the estimated first technology resources, are fulfilled, and
when the one or more criteria are fulfilled, adjust a priority order for the upcoming first technology transmission to be lower than a given priority order in the radio resource to be shared, which adjusted priority order is adapted to be in favour for the second technology transmissions, and
when the one or more criteria are not fulfilled, keep the given specific priority order for the upcoming first technology transmission in the radio resource to be shared.

The network node 110 may further be configured to:
Estimate second technology resources used for second technology transmissions in the shared radio resource, and
estimate the first technology resources used in first technology transmissions in the shared radio resource, by further taking the estimated second technology resources into consideration.

In some embodiments, the network node 110 is further configured to schedule the upcoming first technology transmission according to the priority order given by the outcome of the determining of whether or not the one or more criteria related to the estimated first technology resources was fulfilled.

The first technology transmissions may relate to transmissions that are bandwidth limited, is adapted to use repeated transmissions.

The one or more criteria related to the estimated first technology resources are adapted to relate to any of:
A DL resource share,
a Signalling Radio Bearer zero, SERB0 , share, and
an UL resource share.

In some embodiments, the one or more criteria are adapted to be represented by three threshold parameters comprising a threshold value for shared radio resources in any of:
Signalling Radio Bearer, SRB, 1 SRB2, and Data Radio Bearer, DRB, first technology resource Downlink, DL,
SRB1, SRB2 and DRB first technology resource Uplink, UL,
SERB0 first technology resource DL, and DL DRBs.

The network node 110 may further be configured to associate a first technology transmission type of the upcoming first technology transmission between the network node 110 and the first technology device 120, with the radio resource to be shared.

The embodiments herein may be implemented through a respective processor or one or more processors, such as at least one processor 360 of a processing circuitry in the network node 110 depicted in FIG. 3a, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 370 comprising one or more memory units. The memory 370 comprises instructions executable by the processor 360 in the network node 110. The memory 370 is arranged to be used to store instructions, data, configurations, and applications to perform the methods herein when being executed in the network node 110.

In some embodiments, a computer program 380 comprises instructions, which when executed by the at least one processor 360, cause the at least one processor 360 of the network node 110 to perform the actions above.

In some embodiments, a respective carrier 390 comprises the respective computer program 380, wherein the carrier 390 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g. stored in the network node 110, that when executed by the respective one or more processors such as the at least one processor 360 described above cause the respective at least one processor 360 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### Embodiments

Below, some example embodiments 1-6 are shortly described. See e.g. FIGS. 1, 2, 3a, and 3b.

Embodiment 1. A method performed by a network node 110, e.g. to handle radio resources for an upcoming first technology transmission between the network node 110 and a first technology device 120, e.g. an Cat-M1, Cat-M or Cat-M2 device, in a wireless communications network 100, which radio resources are shared between first technology transmissions and second technology transmissions, wherein the first technology transmissions relate to transmissions that are bandwidth limited, and e.g. are adapted to use repeated transmissions, such as e.g. Cat-M1, Cat-M and Cat-M2 transmissions, and wherein the second technology transmissions relate to any one or more out of: Long Term Evolution, LTE, and New Radio, NR, transmissions, the method comprising:
estimating 203 first technology resources used for first technology transmissions in a shared radio resource, and
determining 204 whether or not one or more criteria related to the estimated first technology resources, e.g. one or more thresholds, are fulfilled, and
when the one or more criteria are fulfilled, e.g. one or more thresholds are exceeded, adjusting 205 a priority order for the upcoming first technology transmission to be lower than a given priority order in the radio resource to be shared, which adjusted priority order is in favour for the second technology transmissions, and
when the one or more criteria are not fulfilled, e.g. the one or more thresholds are not exceeded, keeping 206 the given specific priority order for the upcoming first technology transmission in the radio resource to be shared.

Embodiment 2. The method according to Embodiment 1, further comprising:
estimating 202 second technology resources used for second technology transmissions in the shared radio resource, and
wherein the estimating 203 of the first technology resources used in first technology transmissions in the shared radio resource, comprises to further take the estimated second technology resources into consideration.

Embodiment 3. The method according to any of the embodiments 1-2, further comprising:
scheduling 207 the upcoming first technology transmission according to the priority order given by the outcome of the determining of whether or not the one or more criteria related to the estimated first technology resources, e.g. one or more thresholds, was fulfilled.

Embodiment 4. A computer program 380 comprising instructions, which when executed by a processor 360, causes the processor to perform actions according to any of the Embodiments 1-3.

Embodiment 5. A carrier 390 comprising the computer program 380 of Embodiment 4, wherein the carrier is one of an electronic signal, an optical signal, an electromagnetic signal, a magnetic signal, an electric signal, a radio signal, a microwave signal, or a computer-readable storage medium.

Embodiment 6. A network node 110, e.g. configured to handle radio resources for an upcoming first technology transmission between the network node 110 and a first technology device 120, e.g. an Cat-M1, Cat-M or Cat-M2 device, in a wireless communications network 100, which radio resources are arranged to be shared between first technology transmissions and second technology transmissions, wherein the first technology transmissions relate to transmissions that are bandwidth limited, and e.g. are adapted to use repeated transmissions, such as e.g. Cat-M1, Cat-M and Cat-M2 transmissions, and wherein the second technology transmissions are adapted to relate to any one or more out of: Long Term Evolution, LTE, and New Radio, NR, transmissions, the network node 110 further being configured to:
estimate, e.g. by means of an estimating unit in the network node 110, first technology resources used for first technology transmissions in a shared radio resource, and
determine e.g. by means of a determining unit in the network node 110, whether or not one or more criteria related to the estimated first technology resources, e.g. one or more thresholds, are fulfilled, and
when the one or more criteria are fulfilled, e.g. one or more thresholds are exceeded, adjust e.g. by means of an adjusting unit in the network node 110, a priority order for the upcoming first technology transmission to be lower than a given priority order in the radio resource to be shared, which adjusted priority order is adapted to be in favour for the second technology transmissions, and
when the one or more criteria are not fulfilled, e.g. the one or more thresholds are not exceeded, keep, e.g. by means of a keeping unit in the network node 110, the given specific priority order for the upcoming first technology transmission in the radio resource to be shared.

Embodiment 7. The network node 110 according to Embodiment 6, further configured to:
estimate, e.g. by means of the estimating unit in the network node 110, second technology resources used for second technology transmissions in the shared radio resource, and
estimate, e.g. by means of the estimating unit in the network node 110, the first technology resources used in first technology transmissions in the shared radio resource, by further taking the estimated second technology resources into consideration.

Embodiment 8. The network node 110 according to any of the embodiments 6-7, further configured to:
schedule the upcoming first technology transmission according to the priority order given by the outcome of the determining of whether or not the one or more criteria related to the estimated first technology resources, e.g. one or more thresholds, was fulfilled.

### Further Extensions and Variations

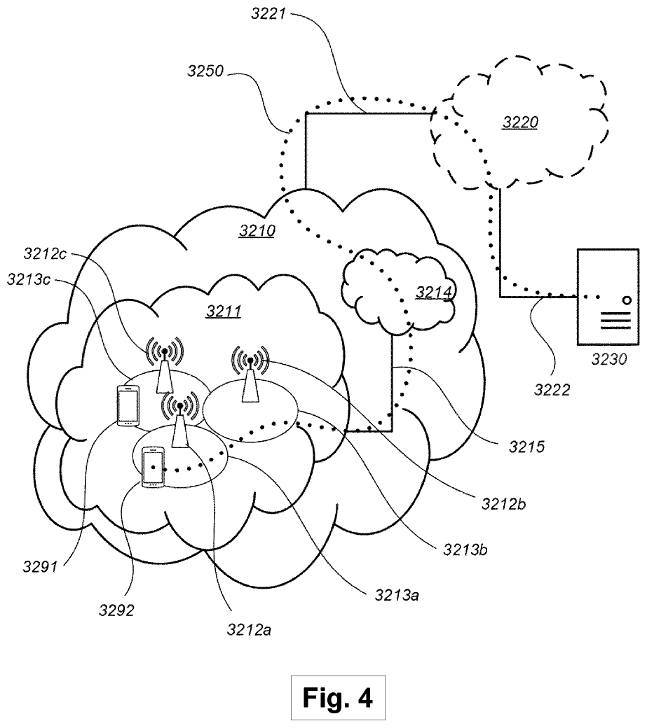

With reference to FIG. 4, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the first technology device 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 4 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

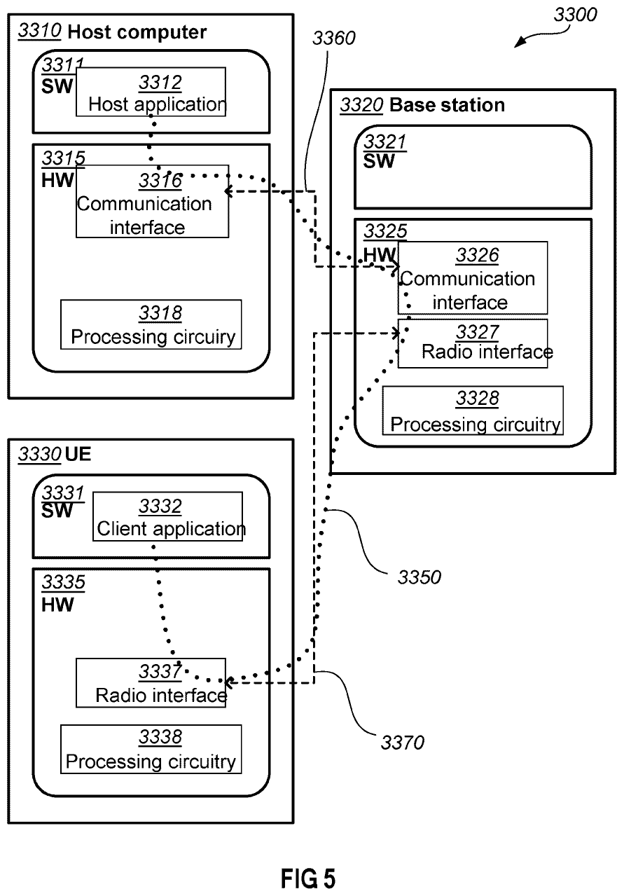

Example implementations, in accordance with an embodiment, of the UE, base station and host computer discussed in the preceding paragraphs will now be described with reference to FIG. 5. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 5) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 5 may be identical to the host computer 3230, one of the base stations 3212a, 3212b, 3212c and one of the UEs 3291, 3292 of FIG. 4, respectively. This is to say, the inner workings of these entities may be as shown in FIG. 5 and independently, the surrounding network topology may be that of FIG. 4.

In FIG. 5, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

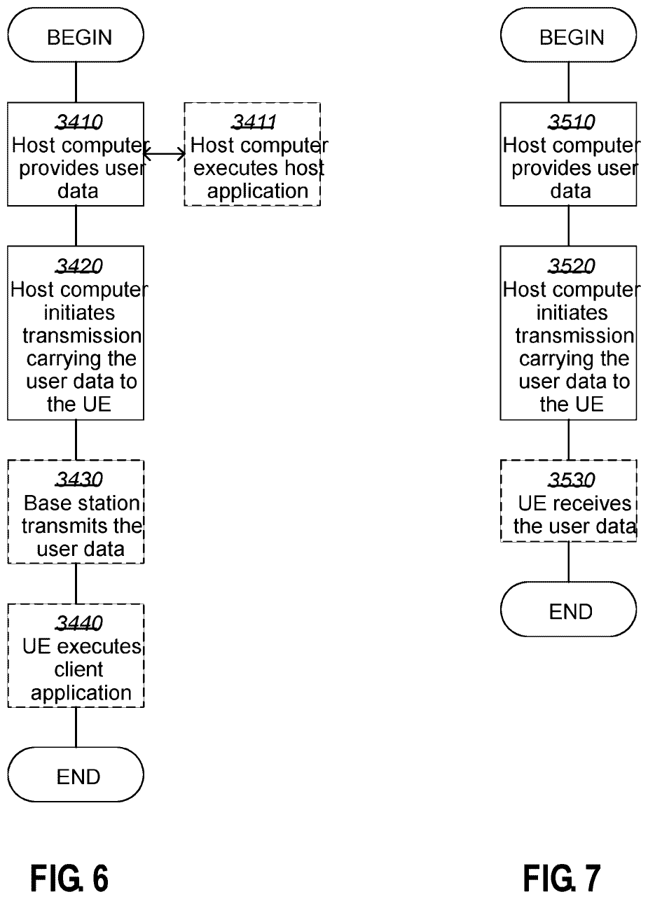

FIG. 6 is a flowchart illustrating a method implemented in a communication system, in accordance with one embodiment. The communication system includes a host computer, a base station such as the network node 112, and a UE such as the first technology device 120, which may be those described with reference to FIG. 4 and FIG. 5. For simplicity of the present disclosure, only drawing references to FIG. 6 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 7 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 7 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

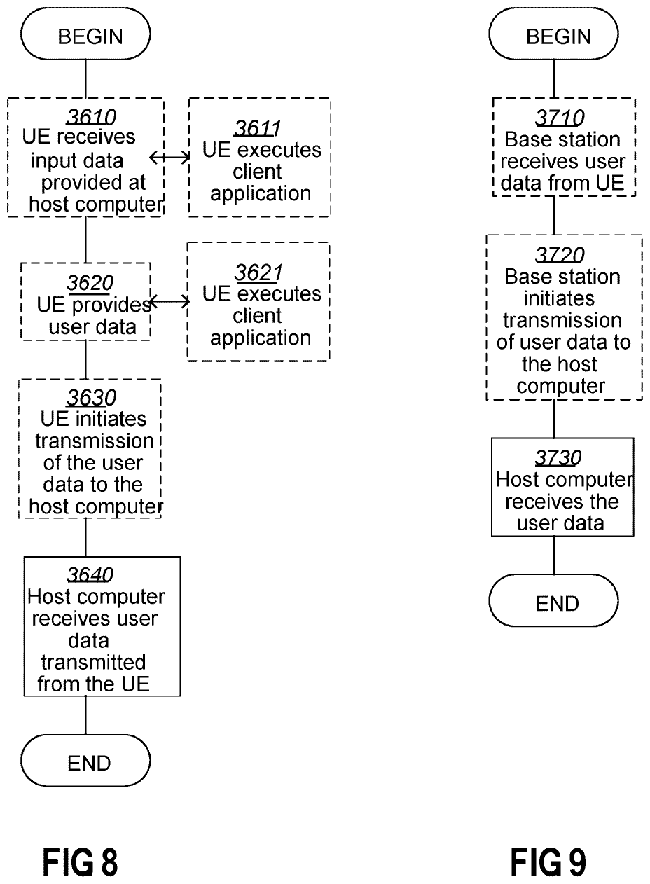

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 4 and FIG. 5. For simplicity of the present disclosure, only drawing references to FIG. 8 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 5. For simplicity of the present disclosure, only drawing references to FIG. 9 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a network node (110), to handle radio resources for an upcoming first technology transmission between the network node (110) and a first technology device (120) in a wireless communications network (100), which radio resources are shared between first technology transmissions and second technology transmissions, wherein the first technology transmissions relate to transmissions that are bandwidth limited, and wherein the second technology transmissions relate to any one or more out of: Long Term Evolution, LTE, and New Radio, NR, transmissions, the method comprising:
estimating (203) first technology resources used for first technology transmissions in a shared radio resource, and
determining (204) whether or not one or more criteria related to the estimated first technology resources are fulfilled, and
when the one or more criteria are fulfilled, adjusting (205) a priority order for the upcoming first technology transmission to be lower than a given priority order in the radio resource to be shared, which adjusted priority order is in favour for the second technology transmissions, and
when the one or more criteria are not fulfilled, keeping (206) the given specific priority order for the upcoming first technology transmission in the radio resource to be shared.

2. The method according to claim 1, further comprising:
estimating (202) second technology resources used for second technology transmissions in the shared radio resource, and
wherein the estimating (203) of the first technology resources used in first technology transmissions in the shared radio resource, comprises to further take the estimated second technology resources into consideration.

3. The method according to claim 1, further comprising:
scheduling (207) the upcoming first technology transmission according to the priority order given by the outcome of the determining of whether or not the one or more criteria related to the estimated first technology resources, was fulfilled.

4. The method according to claim 1, wherein the first technology transmissions relating to transmissions that are bandwidth limited, uses repeated transmissions.

5. The method according to claim 1, wherein the one or more criteria related to the estimated first technology resources relate to any of:
a DL resource share,
a Signalling Radio Bearer zero, SERB0 , share,
an UL resource share.

6. The method according to claim 1, wherein the one or more criteria are represented by three threshold parameters, comprising a threshold value for shared radio resources in any of:
Signalling Radio Bearer, SRB, 1 SRB2, and Data Radio Bearer, DRB, first technology resource Downlink, DL,
SRB1, SRB2 and DRB first technology resource Uplink, UL,
SRB0 first technology resource DL, and DL DRBs.

7. The method according to claim 1, further comprising:
associating (201) a first technology transmission type of the upcoming first technology transmission between the network node 110 and the first technology device 120, with the radio resource to be shared.

8-9. (canceled)

10. A network node (110) configured to handle radio resources for an upcoming first technology transmission between the network node (110) and a first technology device (120) in a wireless communications network (100), which radio resources are arranged to be shared between first technology transmissions and second technology transmissions, wherein the first technology transmissions relate to transmissions that are bandwidth limited, and wherein the second technology transmissions are adapted to relate to any one or more out of: Long Term Evolution, LTE, and New Radio, NR, transmissions, the network node (110) further being configured to:
estimate, first technology resources used for first technology transmissions in a shared radio resource, and
determine whether or not one or more criteria related to the estimated first technology resources, are fulfilled, and
when the one or more criteria are fulfilled, adjust a priority order for the upcoming first technology transmission to be lower than a given priority order in the radio resource to be shared, which adjusted priority order is adapted to be in favour for the second technology transmissions, and
when the one or more criteria are not fulfilled, keep the given specific priority order for the upcoming first technology transmission in the radio resource to be shared.

11. The network node (110) according to claim 10, further configured to:
estimate second technology resources used for second technology transmissions in the shared radio resource, and
estimate the first technology resources used in first technology transmissions in the shared radio resource, by further taking the estimated second technology resources into consideration.

12. The network node (110) according to claim 10, further configured to:
schedule the upcoming first technology transmission according to the priority order given by the outcome of the determining of whether or not the one or more criteria related to the estimated first technology resources was fulfilled.

13. The network node (110) according to claim 10, wherein the first technology transmissions relating to transmissions that are bandwidth limited, is adapted to use repeated transmissions.

14. The network node (110) according to claim 10, wherein the one or more criteria related to the estimated first technology resources are adapted to relate to any of:
a DL resource share,
a Signalling Radio Bearer zero, SRB0, share,
an UL resource share.

15. The network node (110) according to claim 10, wherein the one or more criteria are adapted to be represented by three threshold parameters comprising a threshold value for shared radio resources in any of:
Signalling Radio Bearer, SRB, 1 SRB2, and Data Radio Bearer, DRB, first technology resource Downlink, DL,
SRB1, SRB2 and DRB first technology resource Uplink, UL,
SRB0 first technology resource DL, and DL DRBs.

16. The network node (110) according to claim 10, further configured to:
associate a first technology transmission type of the upcoming first technology transmission between the network node 110 and the first technology device 120, with the radio resource to be shared.
